(19) United States
(12) Patent Application Publication
(10) Pub. No.: US 2023/0161386 A1
(43) Pub. Date: May 25, 2023

(54) Cell Phone Gripper

(71) Applicant: Alyse Nicole Merritt, Odessa, FL (US)

(72) Inventor: Alyse Nicole Merritt, Odessa, FL (US)

(21) Appl. No.: 18/159,179

(22) Filed: Jan. 25, 2023

Related U.S. Application Data
(63) Continuation-in-part of application No. 29/839,000, filed on May 17, 2022.
Application No. 29/839,000 is a continuation-in-part of application No. 29/839,003, filed on May 17, 2022.
(60) Provisional application No. 62/887,089, filed on Aug. 15, 2019.

(51) Int. Cl. G06F 1/16

(52) U.S. Cl. CPC G06F 1/166; G06F 1/1671

(57) ABSTRACT

The present invention provides a device comprising: a case shell having cavities and protrusions, a screen cover with a plurality of buttons, a plurality of connectors, and a cover light. The present invention further includes a stand positioned along the back side of the case shell, wherein the stand extends outwards from the back side of the case shell.

### FIELD OF THE INVENTION

The present invention relates generally to a case for a mobile phone, as well as can more specifically relate to the actual shape of a mobile phone itself, in order to facilitate better functionality for a user. The present invention is a device that aids accessibility for better gripping, for better typing on keys, for those that are hard of seeing with a three-dimensional screen protector design, as well as can allow for various colors and brightness levels of illumination.

### BACKGROUND OF THE INVENTION

Mobile phones and electronic devices have become a part of everyday life for many individuals. These electronic devices aid individuals in completing various tasks and communicating in a timely manner. Many of the mobile phones are designed with a similar rectangular shape and is standard across the industry. While many individuals have no problem holding and typing with a mobile phone, there are still many who have strained eyesight, motor skill issues, large fingers, and other issues preventing easy dialing or viewing the electronic screen. Many products have attempted to alleviate the issue of gripping the phone with rubberized phone cases, however, many of these phone cases still match the shape of the phone and do not provide any ergonomic benefit to the user. Further, many products have been designed to help hold the phone upwards on a surface, but many of these products must be inconveniently attached to the back of the phone taking up lots of space or easily fall off with improper adhesive attachment. An objective of the present invention is to provide users with a cell phone gripper, or with better technology for the actual phone itself to act as a gripper, having better ergonomic shape and function, to improve gripping, better holding, illumination of any color for easier dialing, easier navigating, and enhanced viewing. The present invention intends to provide users with a device that can improve the ease of use for individuals with bad eyesight or with low dexterity in their fingers. In order to accomplish that, a preferred embodiment of the present invention comprises a case shell, a screen cover, and a stand. Further, the stand allows the present invention to hold a phone upwards on a surface. Further another enhancement of the invention is the capability of a greater illumination, which can be of any color, and can allow the user for better visualization of the keys as well, or potentially used as a guiding light when walking, to find keys, or when used anywhere in the dark. Thus, the present invention is an innovative cell phone gripper that provides increased accessibility for individuals with bad eyesight and low finger dexterity with cell phone use while providing an aesthetically pleasing design.

### SUMMARY OF THE INVENTION

The present invention is a cell phone gripper to help with allowing individuals to use their phones easier. The present invention seeks to provide users with a device that can increase visibility, stand upwards on its own, illumination of any color, and increase the ease of holding. In order to accomplish this the present invention comprises a case shell that provides an ergonomic design to the user. Further, the screen cover increases the accessibility and visibility for individuals with low dexterity or bad vision. Additionally, the stand allows the present invention to be positioned upwards without any external devices. Thus, the present invention is an innovative cell phone gripper that provides increased accessibility for individuals with bad eyesight and low finger dexterity with cell phone use while providing added illumination and an aesthetically pleasing design.

### BRIEF DESCRIPTION OF THE DRAWINGS

FIG. 1 is a perspective view of the present invention.

FIG. 2 is a front view of the present invention.

FIG. 3 is a rear view of the present invention.

FIG. 4 is a right-side view of the present invention.

FIG. 5 is a left-side view of the present invention.

FIG. 6 is a top view of the present invention.

FIG. 7 is a bottom view of the present invention.

FIG. 8 is a cross sectional view of one embodiment showing the connectors attached to the screen cover of present invention.

### DETAIL DESCRIPTIONS OF THE INVENTION

All illustrations of the drawings are for the purpose of describing selected versions of the present invention and are not intended to limit the scope of the present invention.

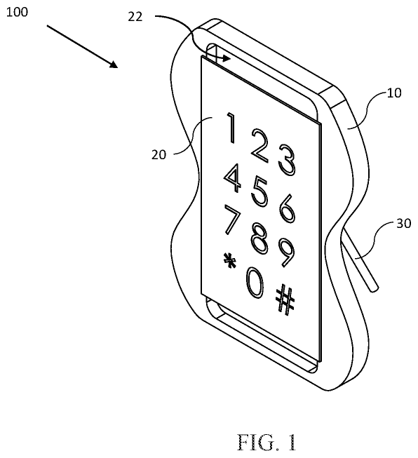

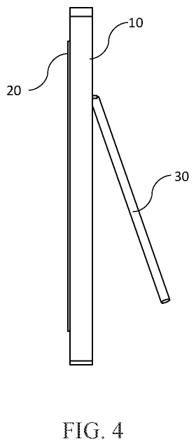

As shown in FIGS. 1-4, the present invention is a cell phone gripper (device) 100. An objective of the present invention is to provide users an aesthetically pleasing device that aids the user with holding a cell phone. The present invention intends to provide users with a device that can increase visibility of the phone screen with upwards standing capacity. To accomplish this the present invention comprises a case shell or casing 10, a screen cover 20, and a stand 30. Many of these components allow for the user to easily hold the device 100 and interact with small icons on an electronic device such as small icons on a phone screen.

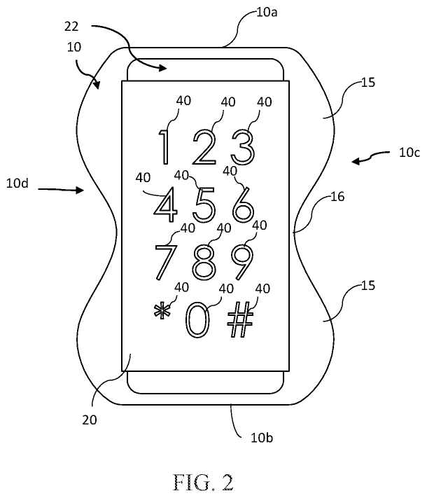

The case shell 10 has the screen cover 20 attached along the front side of the present invention as shown in FIG. 2. Along the back side of the case shell 10 is the stand 30 that extends outwards to allow a phone to stand upwards vertically. Thus, the present invention is an innovative cell phone gripper 100 that provides increased accessibility for individuals with bad eyesight and low finger dexterity with cell phone use while providing an aesthetically pleasing design.

The present invention holds a cell phone with the case shell 10. In one embodiment, the case shell 10 is designed with a sturdy rubber material with rectangular shape that can encompass a mobile phone or any other similar electronic devices.

In one embodiment, the device 100 of the present invention can be shaped to fit comfortably within a user's hand. The case shell 10 can be formed from a pliable medium or deformable medium, such as foamed polyurethane plastic or sponge rubber, that deforms in response to the user's grip. The case shell 10 can also be elastic so that it will return to its original shape when the user's grip loosens.

In some embodiments, the case shell 10 may define a recess 22 sized to receive at least a portion of an electronic device therein. In some embodiments, the recess 22 may include a fastener configured to hold an electronic device therein. Such fasteners include a snap fit fastener or a magnetic clasp.

The plurality of ridges (protrusion) 15 can be placed on the case shell 10 and can be designed with a suitable material with a rounded shape. In some embodiments, the plurality of ridges (protrusion) 15 can be made from a sturdy rubber material.

The ridges (protrusion) 15 can be positioned along the left and right edge (surface) of the case shell 10 as seen in FIGS. 1 to 3.

In one embodiment, the ridges (protrusion) 15 may form protrusions 15 and cavities 16, the case shell 10 may include a top surface 10a and a bottom surface 10b, a right surface 10c and a left surface 10d, the right surface 10c of the device 100 includes a plurality of spaced apart cavities 16 and a plurality of spaced apart protrusions 15, which sequentially are a first protrusion 15 beginning at the first end, a first cavity 16, and a last protrusion 15 terminating in the bottom end, the left surface 10d of the device 100 includes a plurality of spaced apart cavities 16 and a plurality of spaced apart protrusions 15, which sequentially are a first protrusion 15 beginning at the first end, a first cavity 16, and a last protrusion 15 terminating in the bottom end.

In its preferred embodiment, the plurality of ridges 15 forms an hourglass shape (e.g., a cavity 16 and two spaced apart protrusions 15) so that the case shell 10 can allow for the present invention to be held easier while retaining a pleasing aesthetic design. The case shell 10 can include any type of hourglass shape (to accommodate any cell phone with an hourglass shape).

The plurality of ridges 15 additionally, allows the device 100 to be stored within a bag, purse, pocket or wallet in an easier manner. It should be further noted that, the case shell 10 can be created in many various shapes and sizes and the plurality of ridges 15 can be designed with many variations while still staying within the scope of the present invention.

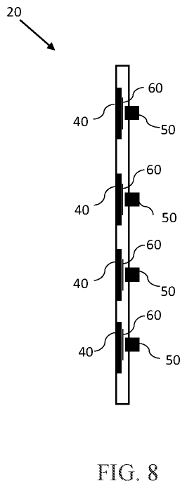

The screen cover 20 connects with the case shell 10 along the front side of the case shell 10. In its preferred embodiment, as shown in FIG. 8, the screen cover 20 comprises a plurality of buttons 40, a plurality of connectors 50 and cover lights 60.

The plurality of buttons 40 is positioned on the front of the screen cover 20. The plurality of buttons 40 can be designed with numbers, letters or symbols in a keyboard form that increases the visibility of a phone screen positioned below the screen cover 20. Further, in some embodiments, the plurality of buttons 40 provides three-dimensionality for the user to easily interact with a phone keyboard/pad.

In some embodiments, the present invention includes a plurality of connectors 50. Positioned below the plurality of buttons 40 is the plurality of connectors 50. The plurality of connectors 50 takes the pressed input from each button 40 and translates it to the phone screen to target the desired area to ensure the button 40 links properly with the right number or letter on the phone screen.

In one embodiment, the connectors 50 may be at least one position adjustable pin 50, as shown in FIG. 8. In some embodiments, the position adjustable pin 50 can be configured to move its position around the center of a button 40. The position adjustable pin 50 may be moved with reference to the center of the corresponding button 40 for a predetermined distance so that the number or symbol on the screen cover 20 matches the corresponding number or symbol on the electronic device (e.g., smart phone). The position of the pin 50 can be made adjustable by using an adjustment mechanism known in the art which allows vertical and/or horizontal movement of the pin 50 with reference to center of a button 40.

Further, below the plurality of buttons 40 is the cover light 60 that illuminates each button 40 with a white color or any other color or illumination-type color to ensure the user can properly see the plurality of buttons 40 with ease. This design allows for the cover light 60 to illuminate the numbers and letters without the light from a phone screen.

In an alternative embodiment, the cover light 60 can be designed with various colors to illuminate the plurality of buttons 40.

In some embodiments, the cover light 60 may be configured to be connected to at least one power source (e.g., a battery that can be placed in the case shell or a cell phone that can provide power).

The stand 30 connects to the back of the case shell 10. In one embodiment, the stand 30 is designed with a metal material with one or more cylindrical (or other shaped) members that have a shorter length than the case shell 10, emanating from the central internal area, bottom area, or back area of the phone.

It should be noted that any material (for the case shell 10 or any cell phone components used with the present invention) should be considered to be within the present scope.

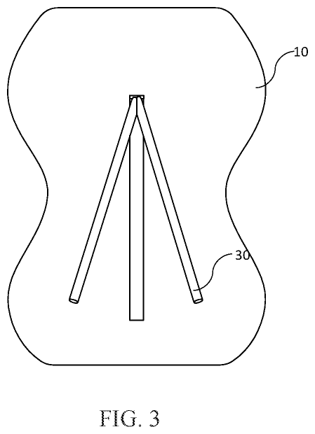

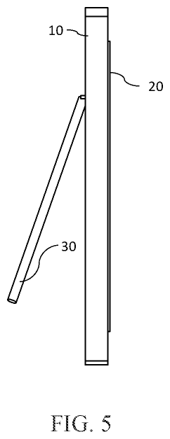

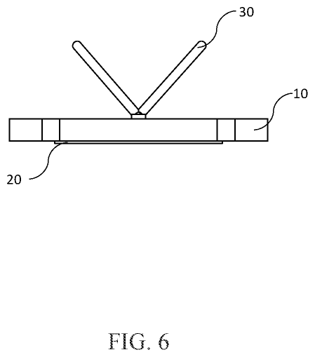

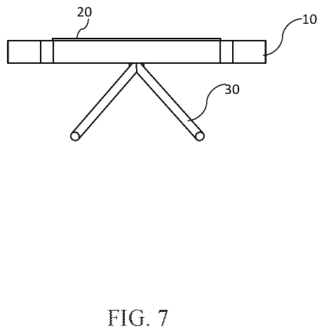

In its preferred embodiment, the stand 30 comprises a hinge known in the art. The hinge connects the stand 30 to the case shell 10. This design allows the stand 30 to easily pivot outwardly from the case shell 10 to from a tripod stand for the present invention as seen in FIGS. 3-7.

In an alternative embodiment, the stand 30 can be designed to fold internally, externally, compress into the case shell 10 or even be completely removable and reconnected via a fastener. Further, in an alternative embodiment the stand 30 can extend outwards from the bottom two corners of the case shell 10. This allows the stand 30 to extend downwards instead of folding outwards to ensure the present invention can stand upright. With all the components working in tandem with each other it can be seen that, the present invention is an innovative cell phone gripper that provides increased accessibility for individuals with bad eyesight and low finger dexterity with cell phone use while providing an aesthetically pleasing design.

It should be noted that all aspects of the components on the phone, the numbers/digits, power buttons, “home” buttons, etc. may all have the capability of being three-dimensional (as well as illuminating), but they don't necessarily have to be in order for the invention to work.

Although the invention has been explained in relation to its preferred embodiment, it is to be understood that many other possible modifications and variations can be made without departing from the spirit and scope of the invention.

What is claimed is:

1. A device comprising:
a case shell including
a top surface and a bottom surface,
a right surface and a left surface,
the right surface of the device includes
a cavity and two spaced apart protrusions that forms an hourglass shape,
the left surface of the device includes
a cavity and two spaced apart protrusions that forms an hourglass shape;
the case shell is deformable and defines a recess sized to receive at least a portion of an electronic device therein;
a screen cover removably attached along the front side of the case shell,
the screen cover includes:
a plurality of buttons, the plurality of buttons is positioned on the front of the screen cover,
a plurality of connectors positioned below the plurality of buttons, the connectors include at least one position adjustable pin, and
a cover light positioned below the plurality of buttons;
and
a stand having a hinge positioned along the back side of the case shell, the stand extends outwards from the back side of the case shell.

2. The device as claimed in claim 1, wherein the case shell is designed with a sturdy rubber material with a rectangular shape that can encompass a mobile phone.

3. The device as claimed in claim 1, wherein the protrusions are made from a sturdy rubber material.

4. The device as claimed in claim 1, wherein the plurality of includes numbers.

5. The device as claimed in claim 1, wherein the plurality of includes letters.

6. The device as claimed in claim 1, wherein the plurality of buttons includes symbols.

7. A device comprising:
a case shell including
a top surface and a bottom surface,
a right surface and a left surface,
the right surface of the device includes
a plurality of spaced apart cavities and a plurality of spaced apart protrusions, which sequentially are a first protrusion beginning at the first end of the right surface, a first cavity, and a last protrusion terminating in the bottom end of the right surface,
the left surface of the device includes
a plurality of spaced apart cavities and a plurality of spaced apart protrusions, which sequentially are a first protrusion beginning at the first end of the left surface, a first cavity, and a last protrusion terminating in the bottom end of the left surface;
the case shell defining a recess which is configured to house an electronic device,
a screen cover removably attached along the front side of the case shell,
the screen cover includes:
a plurality of buttons, the plurality of buttons is positioned on the front of the screen cover,
a plurality of connectors positioned below the plurality of buttons, the connectors include at least one position adjustable pin, and
a cover light positioned below the plurality of buttons;
and
a stand designed to fold, positioned along the back side of the case shell, the stand extends outwards from the back side of the case shell.

8. The device as claimed in claim 7, wherein the case shell is designed with a sturdy rubber material with a rectangular shape that can encompass a mobile phone.

9. The device as claimed in claim 7, wherein the protrusions are made from a sturdy rubber material.

10. The device as claimed in claim 7, wherein the plurality of includes numbers.

11. The device as claimed in claim 7, wherein the plurality of includes letters.

12. The device as claimed in claim 7, wherein the plurality of buttons includes symbols.

13. The device as claimed in claim 7, wherein the stand is designed to compress into the case shell.

14. The device as claimed in claim 7, wherein the stand is removable from the case shell.

15. A device comprising:
a case shell including
a top surface and a bottom surface having a flat surface,
a right surface and a left surface,
the right surface of the device includes
a plurality of spaced apart cavities and a plurality of spaced apart protrusions, which sequentially are a first protrusion beginning at the first end of the right surface, a first cavity, and a last protrusion terminating in the bottom end of the right surface,
the left surface of the device includes
a plurality of spaced apart cavities and a plurality of spaced apart protrusions, which sequentially are a first protrusion beginning at the first end of the left surface, a first cavity, and a last protrusion terminating in the bottom end of the left surface;
the case shell defining a recess which is configured to house an electronic device,
a screen cover removably attached along the front side of the case shell,
the screen cover includes:
a plurality of buttons,
a plurality of connectors positioned below the plurality of buttons, the connectors include at least one position adjustable pin, the plurality of buttons is positioned on the front of the screen cover, and
a cover light positioned below the plurality of buttons;
and
a removable stand positioned along the back side of the case shell, the stand extends outwards from the bottom two corners of the back side of the case shell.

16. The device as claimed in claim 15, wherein the case shell is designed with a sturdy rubber material with a rectangular shape that can encompass a mobile phone.

17. The device as claimed in claim 15, wherein the protrusions are made from a sturdy rubber material.

18. The device as claimed in claim 15, wherein the plurality of buttons includes numbers.

19. The device as claimed in claim 15, wherein the plurality of buttons includes letters.

20. The device as claimed in claim 15, wherein the plurality of buttons includes symbols.
